(19) United States
(12) Patent Application Publication
(10) Pub. No.: US 2009/0271507 A1
(43) Pub. Date: Oct. 29, 2009

(54) SYSTEM AND METHOD FOR ASSISTED ADMINISTRATION OF REMOTE DEVICE UPDATES

(76) Inventor: Marianne L. KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/109,018

(22) Filed: Apr. 24, 2008

(51) Int. Cl. G06F 9/44; G06F 15/173

(52) U.S. Cl. 709/224; 717/172

(57) ABSTRACT

The subject application is directed to a system and method for assisted administration of remote device updates. Device data is first received for each networked document processing device that includes data representing the current state of the hardware and software associated with each of the networked document processing devices. Update data is then received including the identity and availability of revised software. A comparison of the update data with the device data is performed. The compatibility of the received update data is determined based upon the comparison, and a display is generated representing each of the compatible devices. Selection data is then received corresponding to each displayed document processing device. The revised software is thereafter communicated to each document processing device identified by the selection data. The revised software is then installed on each device to which it was communicated.

### BACKGROUND OF THE INVENTION

The subject application is generally directed to remote updating of device software. It is particularly applicable to maintenance of software installed in a large number of document processing devices distributed throughout an enterprise.

Modern day computers are widely integrated into the workplace. These devices include not only user workstations, but also embedded computers, such as those found in controllers of document processing devices. Document processing devices include copiers, printers, facsimile machines, scanners, or devices having two or more of these functions which are referred to as multifunction peripherals or MFPs. Document processing devices can be very powerful, and require many complex controls and monitors to function. A typical document processing device relies on the embedded controller computer to accomplish these functions, as well as to generate a user interface that allows for straightforward user control of complex functions.

Controllers, like any other computer, will periodically benefit by newer versions of software. Updating of software for one or two devices is straightforward, and is suitably accomplished by bringing a new code version to the device via portable data storage, such as CD, DVD, USB driver, floppy disk, or the like. Since many document processing devices are networked, more recent advances allow for remote pushes of software to devices, or provide sufficient intelligence in controllers to allow them to pull down available updates.

Maintenance of large installations of devices, particularly devices of different manufacture or devices having different hardware and software versions, requires administrators to keep track of each individual device, determine when updates are available, determine which devices are compatible with an available update, and determine which machines should be updated and which should not. The administrator must then address each update situation uniquely, requiring a large time investment in a process that is prone to error by improper installation.

### SUMMARY OF THE INVENTION

In accordance with one embodiment of the subject application, there is provided a system and method for remote updating of device software.

Further, in accordance with one embodiment of the subject application, there is provided a system and method for maintaining software installed in a large number of document processing devices distributed throughout an enterprise.

Still further in accordance with one embodiment of the subject application, there is provided a system for assisted administration of remote device updates. The system comprises means adapted for receiving device data corresponding to each of a plurality of networked document processing devices, the device data including data representative of a current state of hardware and software of each of the document processing devices and means adapted for receiving update data corresponding to an identity and availability of revised software. The system also comprises comparison means adapted for comparing received update data with received device data, means adapted for determining compatibility of received update data with received device data in accordance with an output of the comparison means, and display means adapted for generating a display representative of each networked document processing device determined to be compatible with the revised software. The system further comprises selection means adapted for receiving selection data corresponding to each displayed document processing device, means adapted for communicating the revised software to each document processing device identified by the selection data, and means adapted for commencing installation of the revised software to each document processing device to which it was communicated.

Still further, in accordance with one embodiment of the subject application there is provided a method for assisted administration of remote device updates. The method includes the step of receiving device data corresponding to each of a plurality of networked document processing devices, where the device data includes data representing a current state of hardware and software of each of the document processing devices. The method further includes the steps of receiving update data corresponding to the identity and availability of revised software, and comparing the received update data with the received device data. The method also comprises the step of determining the compatibility of the received update data with the received device data according to the output of the comparison step. In addition, the method includes the step of generating a display representing each networked document processing device determined to be compatible with the revised software. The method further comprises the steps of receiving selection data corresponding to each displayed document processing device, and communicating the revised software to each document processing device identified by the selection data. Furthermore, the method comprises the step of commencing installation of the revised software to each document processing device to which it was communicated.

Still other advantages, aspects and features of the subject application will become readily apparent to those skilled in the art from the following description wherein there is shown and described a preferred embodiment of the subject application, simply by way of illustration of one of the modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for assisted administration of remote device updates according to one embodiment of the subject application;

FIG. 2 is a block diagram illustrating device hardware for use in the system for assisted administration of remote device updates according to one embodiment of the subject application;

FIG. 3 is a functional diagram illustrating the device for use in the system for assisted administration of remote device updates according to one embodiment of the subject application;

FIG. 4 is a block diagram illustrating controller hardware for use in the system for assisted administration of remote device updates according to one embodiment of the subject application;

FIG. 5 is a functional diagram illustrating the controller for use in the system for assisted administration of remote device updates according to one embodiment of the subject application;

FIG. 6 is a functional diagram illustrating a user device for use in the system for assisted administration of remote device updates according to one embodiment of the subject application;

FIG. 7 is a flowchart illustrating a method for assisted administration of remote device updates according to one embodiment of the subject application; and

FIG. 8 is a flowchart illustrating a method for assisted administration of remote device updates according to one embodiment of the subject application.

### DETAILED DESCRIPTION OF THE PREFERRED EMBODIMENT

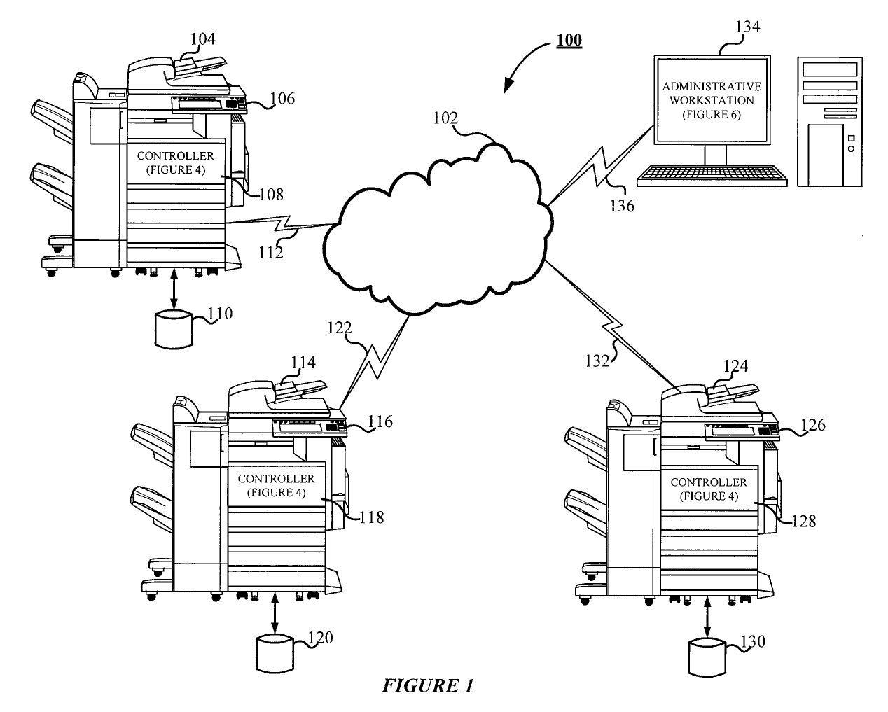

The subject application is directed to a system and method for remote updating of device software. In particular, the subject application is directed to a system and method for maintaining software installed in a large number of document processing devices distributed throughout an enterprise. More particularly, the subject application is directed to a system and method for assisted administration of remote device updates. It will become apparent to those skilled in the art that the system and method described herein are suitably adapted to a plurality of varying electronic fields employing remote computing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for assisted administration of remote device updates in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also contains one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, and any suitable combination thereof, configured to interact with an associated user, a networked device, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

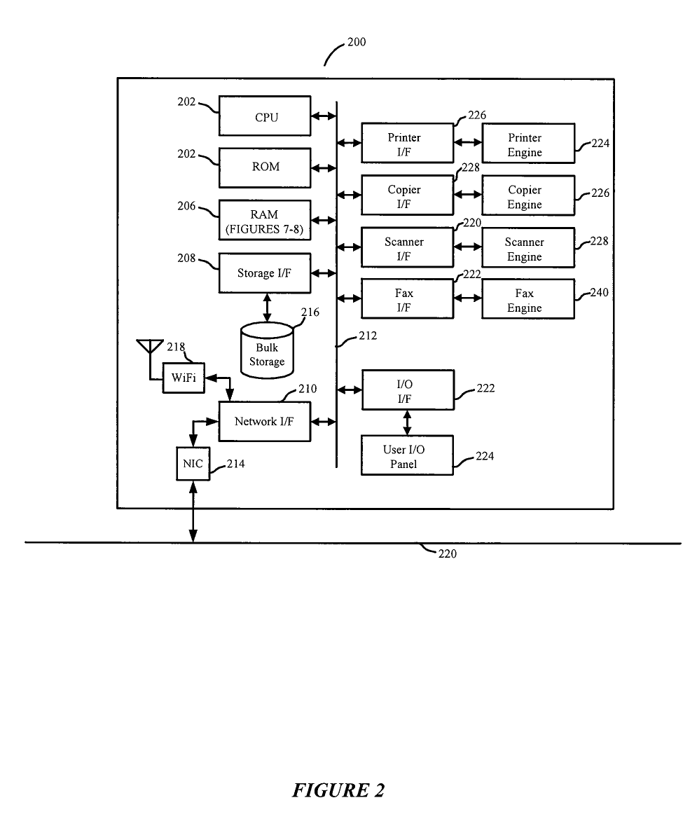

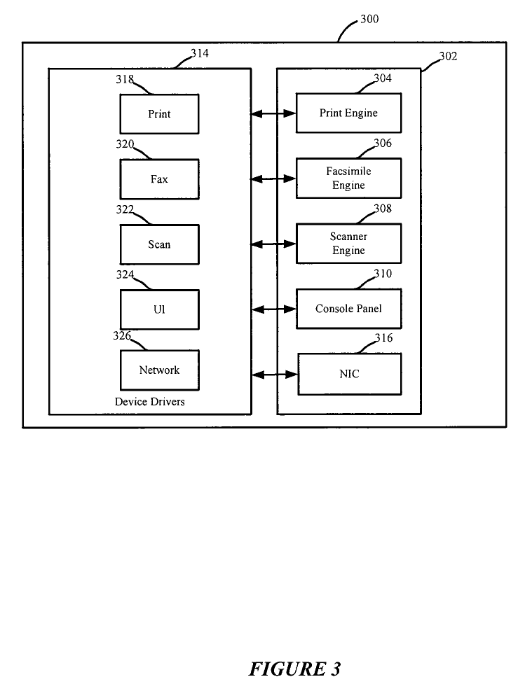

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

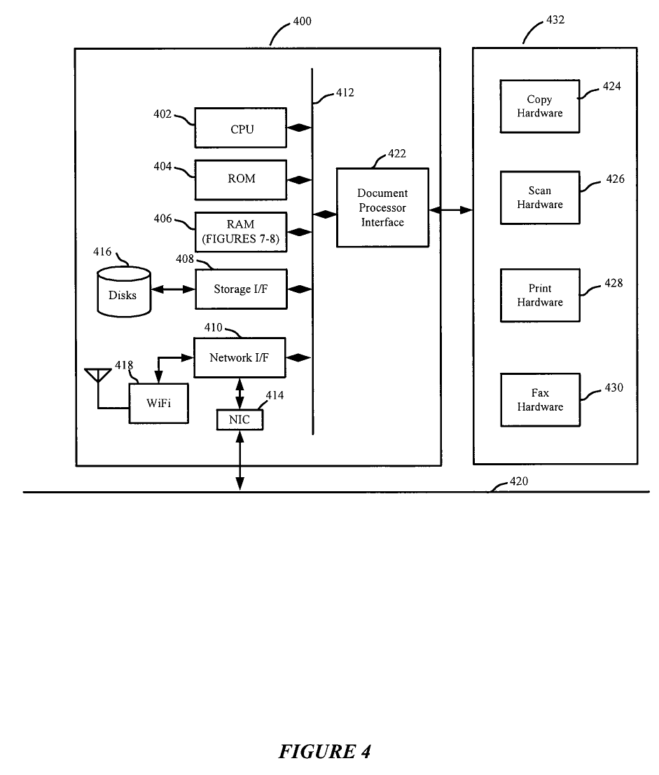

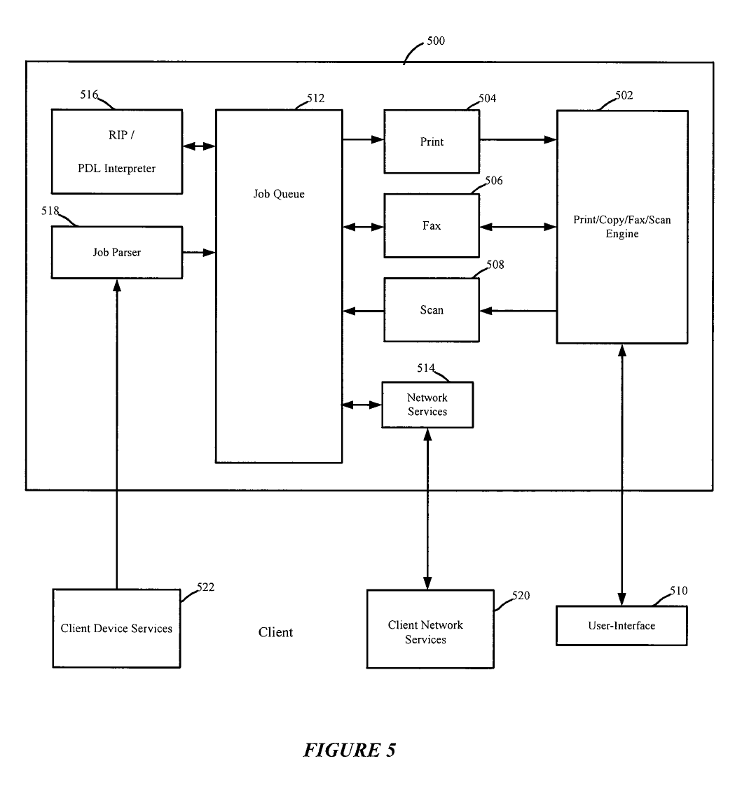

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for assisted administration of remote device updates of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

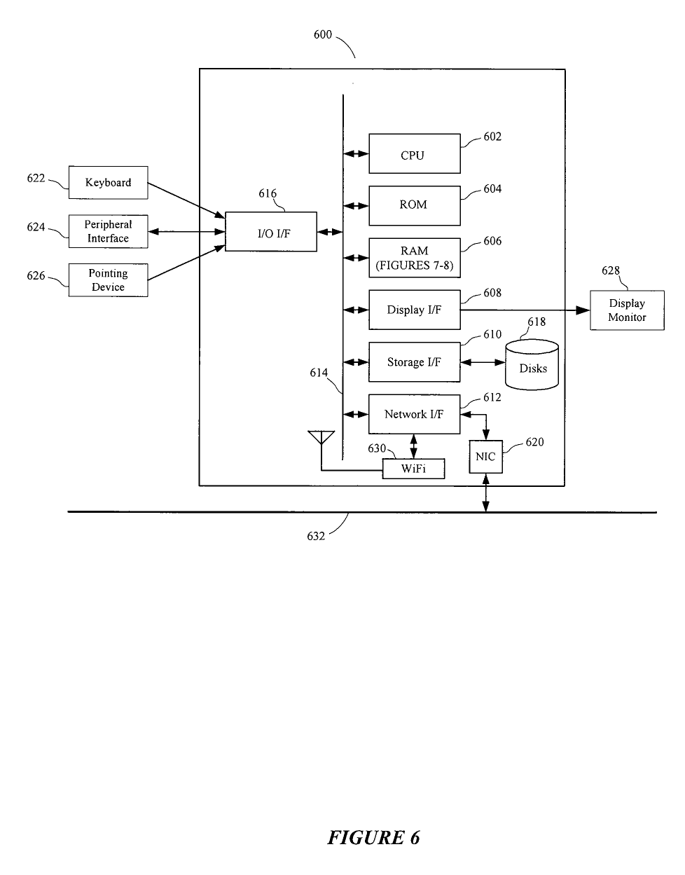

The system 100 illustrated in FIG. 1 further depicts an administrative workstation 134, in data communication with the computer network 102 via a communications link 136. It will be appreciated by those skilled in the art that the administrative workstation 134 is shown in FIG. 1 as a computer workstation for illustration purposes only. As will be understood by those skilled in the art, the administrative workstation 134 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 136 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative workstation 134 is suitably adapted to monitor operations of the computer network 102, the document processing devices 104, 114, and 124, or any other similar device coupled to the computer network 102, assisted administration of remote device updates and the like. The functioning of the user device 158 will better be understood in conjunction with the block diagram illustrated in FIG. 6, explained in greater detail below.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface s subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104, 114, and 124, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative workstation 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

In operation, device data is first received corresponding to each networked document processing device of a computer network. The device data preferably includes data representing the current state of the hardware and software associated with each of the networked document processing devices. Update data corresponding to the identity and availability of revised software is then received and a comparison of the update data with the device data is performed. The compatibility of the received update data is then determined based upon the results of the comparison with the device data. A display is then generated representing each of the networked document processing devices determined to be compatible with the revised software. Selection data is then received corresponding to each displayed document processing device. The revised software is thereafter communicated to each document processing device identified by the selection data. The installation of the revised software is then commenced to each document processing device to which it was communicated.

In accordance with one example embodiment of the subject application, an administrative workstation 134 receives device data corresponding to each document processing device 104, 114, and 124 coupled to the computer network 102. The device data suitably includes, for example and without limitation, the current hardware configuration, the current software configuration, the network address, the device name, and the like. Preferably, the workstation 134 receives such device data via the computer network 102. The administrative workstation 134 then receives version data corresponding to the version of the software operative on each of the networked document processing devices 104, 114, and 124.

The administrative workstation 134 then generates a graphical display depicting each networked device 104, 114, and 124 along with associated device information, i.e. the device name, device network address, software version, and the like. It will be appreciated by those skilled in the art that the display of such device information on the workstation 134 is accomplished via any suitable means known in the art including, for example and without limitation, hardware, software, or a combination thereof, configured in accordance with the subject application.

Location data is then received by the administrative workstation 134 corresponding to an update source of revised software, e.g. a network address, drive, folder, or other suitable designation. In accordance with one embodiment of the subject application, the location is selected by an administrative user associated with the administrative workstation 134. The administrative workstation 134 then searches for revised software availability from available update locations. Preferably, the workstation 134 searches the designated locations so as to locate any available revised software in that location, e.g. a local hard disk drive, a removable storage medium, or the like.

The workstation 134 then determines for the first document processing device 104 whether revised software is available. When revised software is not available, the display on the workstation 134 is updated to indicate that no revised software is available for the first document processing device 104 and operations proceed to the next document processing device, e.g. the second document processing device 114. When there is revised software available for the second device 114, the source identity of the revised software is displayed on the workstation 134 based upon the location data. Preferably, detailed information, e.g. version information, author information, and the like, is also retrieved and displayed on the workstation 134 corresponding to the available revised software. The third document processing device 124 is then processed as set forth above, and any revised software is so indicated on the display of the workstation 134. In the event that no revised software is available for any of the networked document processing devices 104, 114, and 124, operations terminate with no updates to the devices 104, 114, and 124 being made.

Once the display has been updated to reflect the available revised software with respect to the networked document processing devices 104, 114, and 124, update data is received by the workstation 134 from the designated location. The workstation 134 then compares the update data to the received device data so as to determine whether the revised software of the update data is compatible with the document processing devices 104, 114, and 124. The display of the workstation 134 is then updated so as to reflect only those document processing devices 104, 114, and 124 for which compatible software is available. That is, the graphical user interface display is updated whereby those document processing devices 104, 114, and 124 that are not compatible with the available revised software are removed. In accordance with one embodiment of the subject application, the display is updated so as to leave all document processing devices 104, 114, and 124 depicted thereon, with suitable indicia on the display indicating those document processing devices 104, 114, and 124 for which revised software is available and indicia indicating those for which revised software is incompatible.

Selection data is then received via the administrative workstation 134 corresponding to each displayed document processing device 104, 114, and 124 for which revised software is available and compatible. Preferably the associated administrator selects one or more of such document processing devices 104, 114, and 124 to which software revision is desired. In accordance with one embodiment of the subject application, the selection is made automatically by the workstation for all suitable displayed document processing devices 104, 114, and 124. Via the workstation 134, an update is initiated for each document processing device 104, 114, and 124 in accordance with the received selection data. According to one embodiment of the subject application, the initiation of the software update occurs automatically upon receipt of the selection data. In accordance with one embodiment of the subject application, the administrative user is suitably prompted to initiate the update of the selected document processing devices 104, 114, and 124.

The administrative workstation 134 then communicates the revised software to each of the selected document processing devices 104, 114, and 124 via the computer network 102. Each recipient document processing device 104, 114, and 124 then commences the installation of the revised software and returns periodic progress or status data to the workstation 134. The administrative workstation 134 then updates the display of the document processing devices 104, 114, and 124 so as to illustrate the progress or status of the update process. It will be appreciated by those skilled in the art that the periodic reporting of update progress is capable of being set by the administrative user, inherent to the revised software, or the like. Preferably, the update is reflected on the display of the workstation 134 in an animated format, so as to show the progress to the administrative user. Once all updates have been completed, operations terminate.

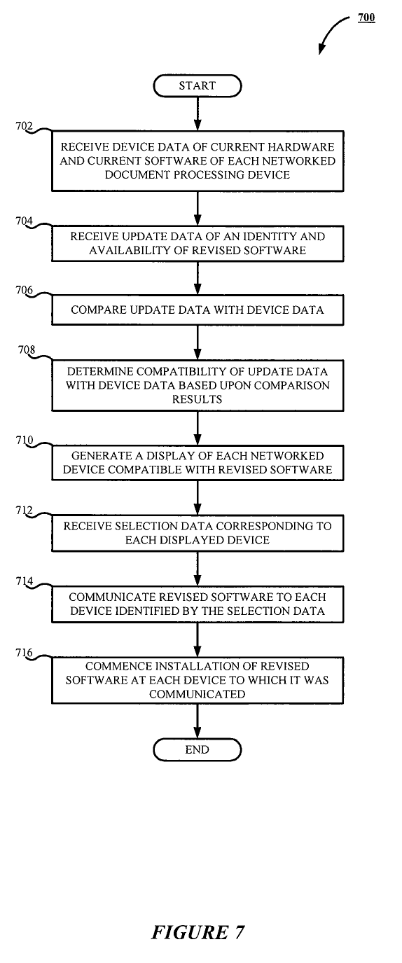

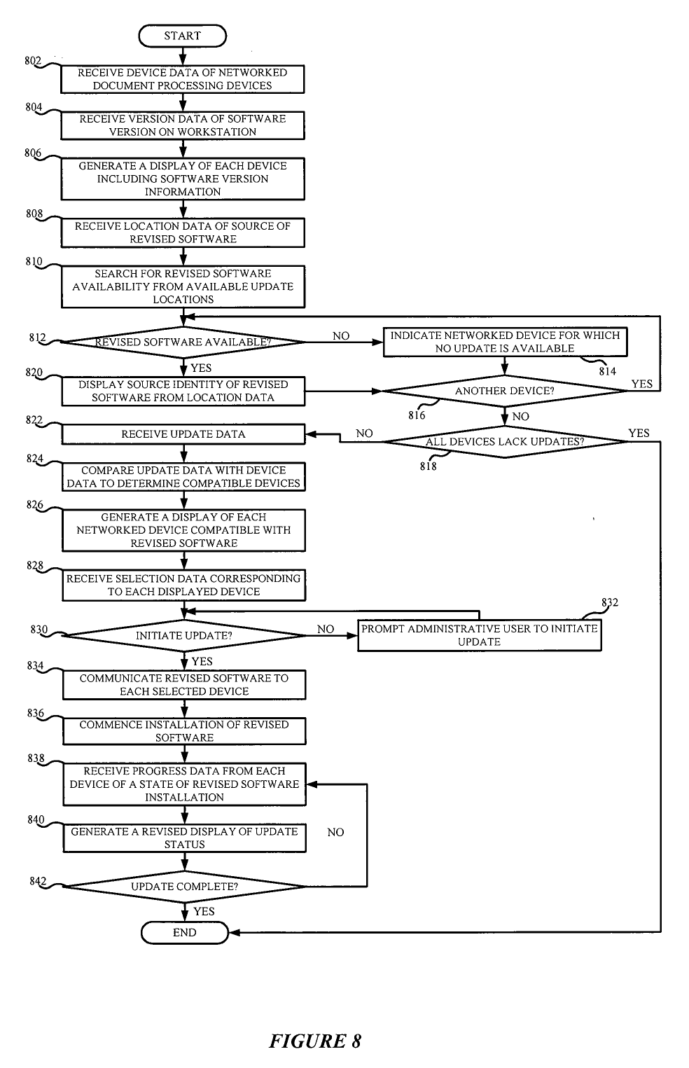

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for assisted administration of remote device updates in accordance with one embodiment of the subject application. Beginning at step 702, device data is received by the administrative workstation 134 representing the current hardware and current software information corresponding to each document processing device 104, 114, and 124 coupled to the computer network 102. Preferably, the received device data includes, for example and without limitation, a network address of each document processing device 104, 114, and 124, a manufacturer, a device name, and the like.

Update data is then received by the administrative workstation 134 at step 704 corresponding to the identity and availability of revised software. In accordance with one embodiment of the subject application, the revised software includes, for example and without limitation, a firmware update, an operating system update, a font update, or the like. At step 706, the received update data is compared with the received device data so as to determine whether the update data is compatible with the device data. It will be understood by those skilled in the art that the comparison performed at step 706 is capable of representing the compatibility of the device operating system with the update, the software version on the device 104, 114, and 124 as compared to the version of the update data, or the like. A determination is then made at step 708 of the compatibility of the update data with the device data in accordance with the results of the comparison performed at step 706. Stated another way, the administrative workstation 134 compares the current device information, e.g. hardware and software, to the revised software in of the update data to determine whether the update is compatible with the document processing device 104, 114, and 124. For example, when the first document processing device 104 is running a WINDOWS-based operating system and the update data corresponds to a LINUX-based operating system, the administrative workstation 134 determines that such an update is not compatible and therefore capable of being ignored.

At step 710, a display is generated on the administrative workstation 134 corresponding to each networked document processing device 104, 114, and 124 compatible with the revised software of the update data. Preferably, the administrative workstation 134 generates a suitable graphical user interface capable of displaying each document processing device 104, 114, and 124 that is compatible with the revised software. For example, a listing of devices 104, 114, and 124 by device name, with associated network address and current hardware/software information is displayed on the administrative workstation 134. Selection data is then received at step 712 corresponding to each displayed device 104, 114, and 124 for receipt of the revised software of the update data. In accordance with one embodiment of the subject application, a system administrator associated with the administrative workstation 134 selects any number of displayed devices 104, 114, and 124 for receipt of the revised software. It will be appreciated by those skilled in the art that the subject application enables the automatic selection of all devices 104, 114, and 124 compatible with the update data, e.g. all devices 104, 114, and 124 displayed on the administrative workstation 134.

The revised software is then communicated from the administrative workstation 134 to each of the networked document processing devices 104, 114, and 124 via the computer network 102 based upon the received selection data at step 714. The controller 108, 118, and 128 or other suitable component associated with each document processing device 104, 114, and 124 then commences the installation of the revised software at step 716.

Referring now to FIG. 8, there is shown a flowchart 8 illustrating a method for assisted administration of remote device updates in accordance with one embodiment of the subject application. The methodology of FIG. 8 begins at step 802, whereupon the administrative device 134 receives device data corresponding to the current hardware and software of each networked document processing device 104, 114, and 124. It will be understood by those skilled in the art that such information is suitably received by the workstation 134 from the controllers 108, 118, and 128 or other suitable component associated with the document processing devices 104, 114, and 124 via the computer network 102. Preferably, the device data further includes, for example and without limitation, the network address, the device name, and the like. At step 804, the workstation receives version data from each of the networked document processing devices 104, 114, and 124 of the software resident thereon.

The administrative workstation 134 then generates a display at step 806 of each networked document processing device 104, 114, and 124 in association with the received device data, e.g., device name, network address, software version, and the like. In accordance with one embodiment of the subject application, the administrative workstation 134 generates a graphical user interface displaying the received device data to an associated administrative user. Location data representing one or more sources of revised software is then received by the administrative workstation at step 808. According to one embodiment of the subject application, suitable location data includes, for example and without limitation, a network address, uniform resource locator, drive, folder, portable storage medium, or the like. The subject application enables the manual selection of the source via input from the associated user, as well as enabling the workstation 134 to perform a suitable search for such location data, as will be understood by those skilled in the art.

At step 810, the administrative workstation 134 performs a search for revised software availability from the available update locations. Preferably, the workstation 134 searches the designated locations so as to locate any available revised software in that location, e.g. a local hard disk drive, a removable storage medium, or the like. A determination is then made at step 812 whether there is revised software available for the first document processing device 104 among those document processing devices 104, 114, and 124 displayed on the administrative device 134. Upon a determination at step 812 that revised software is not available for the first document processing device 104, flow proceeds to step 814, whereupon the display on the workstation 134 is updated to indicate that no revised software is available for the first document processing device 104. A determination is then made at step 816 whether another document processing device, e.g. devices 114 and 124, remain for processing. Upon a determination at step 816 that the second and third document processing devices 114 and 124 remain, flow returns to step 812, whereupon a determination is made whether revised software is available for the second document processing device 114. When it is determined at step 812 that revised software is available, flow proceeds to step 820, whereupon the source identity of the software is displayed on the workstation 134 in accordance with location data. Preferably, detailed information, e.g. version information, author information, and the like, is also retrieved and displayed on the workstation 134 corresponding to the available revised software. Operations then proceed to step 816, whereupon the determination is made that another document processing device 124 remains and flow returns to step 812.

Upon a determination at step 812 that revised software is available for the third document processing device 124, flow proceeds to step 820 and the display of the workstation 134 is suitably updated as set forth above with respect to the second document processing device 114. Following a determination at step 816 that no other document processing devices remain for analysis, flow proceeds to step 818. At step 818, a determination is made whether all networked document processing devices 104, 114, and 124 lack revised software. In such an event, operations with respect to FIG. 8 terminate with no updates of document processing device 104, 114, and 124 software performed.

Continuing with the example above where the first device 104 lacks revised software and the second and third devices 114 and 124, flow progresses from step 818 to step 822, whereupon update data is received by the administrative workstation 134. Preferably, the workstation 134 receives the update data, inclusive of such revised software, via the identified source. It will be understood by those skilled in the art that the workstation 134 is capable of retrieving such software from the source, e.g. “pulled” or have the software automatically downloaded to the workstation, e.g. “pushed”.

The administrative workstation 134 then compares the update data with the received device data at step 824 so as to determine whether the revised software of the update data is compatible with the second and third document processing devices 114 and 124, i.e. those document processing device 114 and 124 for which revised software was determined available. At step 826, the display of the workstation 134 is updated so as to reflect only those document processing devices 114 and 124 for which compatible software is available.

That is, the graphical user interface display is updated whereby the document processing devices 104, 114, and 124 that are not compatible with the available revised software are removed. In the aforementioned example, as the first document processing device 104 already lacks available software, it is removed from the display of the workstation 134. In accordance with one embodiment of the subject application, the display is updated so as to leave all document processing devices 104, 114, and 124 depicted thereon, with suitable indicia on the display indicating those document processing devices 114 and 124 for which revised software is available and indicia indicating the device 104 for which revised software is unavailable/incompatible.

At step 828, selection data corresponding to each displayed document processing device 114 and 124 is received via the administrative workstation 134. For example, the associated administrative user selects one or more of such document processing devices 114 and 124 for which software revision is desired. In accordance with one embodiment of the subject application, the selection is made automatically by the workstation for all suitable displayed document processing devices 114 and 124.

A determination is then made at step 830 whether the update of the selected document processing devices 114 and 124 has been initiated. According to one embodiment of the subject application, the initiation of the software update occurs automatically upon receipt of the selection data. When it is determined at step 830 that the update has not yet been initiated, flow proceeds to step 832, whereupon the administrative user is suitably prompted to initiate the update of the selected document processing devices 104, 114, and 124.

Upon a determination at step 830 that the update has been initiated, flow proceeds to step 834, whereupon the administrative workstation 134 communicates the revised software to each of the selected document processing devices 114 and 124 via the computer network 102. The selected document processing devices 114 and 124 then receive the revised software and commence installation at step 836. At step 838, workstation 134 then receives progress data of the status of the software installation from the controllers 118 and 128 or other suitable components associated with the selected document processing devices 114 and 124. A revised display is then generated on the workstation 134 reflecting the update status of each of the selected document processing devices 114 and 124.

A determination is then made at step 842 whether the update of each document processing device 114 and 124 has been completed. Upon a negative determination at step 842, flow returns to step 838, whereupon progress data is received from each document processing device 114 and 124. In accordance with one embodiment of the subject application, the document processing devices 114 and 124 periodically report the progress of the revised software installation to the workstation 134 via the computer network 102. According to one embodiment of the subject application, the progress of the revised software installation is reflected on the display of the workstation 134 in an animated format, so as to show the status of the installation to the administrative user. Upon a determination at step 842 that all updates have been completed, operations with respect to FIG. 8 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for assisted administration of remote device updates comprising:
means adapted for receiving device data corresponding to each of a plurality of networked document processing devices, the device data including data representative of a current state of hardware and software of each of the document processing devices;
means adapted for receiving update data corresponding to an identity and availability of revised software;
comparison means adapted for comparing received update data with received device data;
means adapted for determining compatibility of received update data with received device data in accordance with an output of the comparison means;
display means adapted for generating a display representative of each networked document processing device determined to be compatible with the revised software;
selection means adapted for receiving selection data corresponding to each displayed document processing device;
means adapted for communicating the revised software to each document processing device identified by the selection data; and
means adapted for commencing installation of the revised software to each document processing device to which it was communicated.

2. The system of claim 2 further comprising means adapted for receiving progress data from each document processing device, wherein the progress data includes data representative of a state of installation of the revised software on an associated document processing device, and wherein the display means includes means adapted for generating a revised display representative of an update status of each document processing device to which the revised software was communicated.

3. The system of claim 2 further comprising means adapted for receiving version data representative of a version of software on an associated workstation, and wherein the display means further includes means adapted for generating a display inclusive of version information corresponding to a software version on each document processing device prior to installation of the revised software.

4. The system of claim 3 further comprising means adapted for receiving location data representative of a source of the revised software, and wherein the display means further includes means adapted for displaying an identity of a source of revised software in accordance with received location data.

5. The system of claim 4 further comprising means adapted for searching for availability of revised software in accordance data representative of available update locations.

6. A method for assisted administration of remote device updates comprising the steps of:
receiving device data corresponding to each of a plurality of networked document processing devices, the device data including data representative of a current state of hardware and software of each of the document processing devices;
receiving update data corresponding to an identity and availability of revised software;
comparing received update data with received device data;
determining compatibility of received update data with received device data in accordance with an output of the comparison step;
generating a display representative of each networked document processing device determined to be compatible with the revised software;
receiving selection data corresponding to each displayed document processing device;
communicating the revised software to each document processing device identified by the selection data; and
commencing installation of the revised software to each document processing device to which it was communicated.

7. The method of claim 6 further comprising the steps of:
receiving progress data from each document processing device, wherein the progress data includes data representative of a state of installation of the revised software on an associated document processing device; and
generating a revised display representative of an update status of each document processing device to which the revised software was communicated.

8. The method of claim 7 further comprising the steps of:
receiving version data representative of a version of software on an associated workstation; and
generating a display inclusive of version information corresponding to a software version on each document processing device prior to installation of the revised software.

9. The method of claim 8 further comprising the steps of:
receiving location data representative of a source of the revised software; and
displaying an identity of a source of revised software in accordance with received location data.

10. The method of claim 9 further comprising the step of searching for availability of revised software in accordance with data representative of available update locations.
